(19) United States
(12) Patent Application Publication
(10) Pub. No.: US 2007/0049851 A1
(43) Pub. Date: Mar. 1, 2007

(54) Breast and abdomen massaging device

(76) Inventor: Horng-Lieh Lin, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/213,759

(22) Filed: Aug. 30, 2005

(51) Int. Cl. A61H 1/00

(52) U.S. Cl. 601/70; 601/134; 601/DIG. 14

(57) ABSTRACT

A device for massing a user's breasts and abdomen simultaneously is provided herein. The massaging device has a T-shaped structure whose two ends of the horizontal bar are configured with two cups for covering the user's breasts respectively, and whose bottom end of the vertical bar is configured with a number of massaging balls. The locations of the cups and the massaging balls could be adjusted manually and independently so as to fit the user's physical characteristics and to rest on the desired locations. The massaging device is equipped with two electrical motors, one for providing larger vibrations and the other one for providing smaller vibrations, to the cups and the massaging balls respectively.

### BACKGROUND OF THE INVENTION

(a) Technical Field of the Invention

The present invention generally relates to massaging devices, and more particularly to a device for massaging the breasts and the abdomen of a user simultaneously.

(b) Description of the Prior Art

Various massaging devices for breasts have been disclosed. For example, the techniques provided by the Republic of China Patent No. 475440, 580383, and 571753 all utilize low-frequency current to deliver localized stimulation to the breasts of a user, in the hope that such repeated stimulation by the low-frequency current would pump up the user's breasts. However, there is not enough clinical data that can support such a claimed effect from the stimulation of the low-frequency current. On the contrary, such application of the low-frequency current to the human body might actually present a hazard to the user.

In addition, the foregoing techniques only focus on the pumping effect of the breasts of a user, which is quite limited in terms of their functionality. For a female user who constantly suffers excruciating abdominal pain during her period, a massaging device that could also ease her discomfort would certainly be of great help to her.

### SUMMARY OF THE INVENTION

The primary purpose of the present invention is to provide a device for massaging a user's breasts and abdomen simultaneously is provided herein. The massaging device of the present invention has a T-shaped structure whose two ends of the horizontal bar are configured with two cups for covering the user's breasts respectively, and whose bottom end of the vertical bar is configured with a number of massaging balls.

The locations of the cups and the massaging balls could be adjusted manually and independently so as to fit the user's physical characteristics and to rest on the desired locations. The massaging device is equipped with two electrical motors, one for providing larger vibrations and the other one for providing smaller vibrations, to the cups and the massaging balls respectively.

The massaging device is also equipped with a control switch for selecting which motor to run so as to massage the breasts only, the abdomen only, or both. The massaging device further contains a timer to provide an automatic shutdown function after a specific period of time.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the various components of the massaging device according to the present invention.

FIG. 2 is a front view showing the inner structure of the massaging device of FIG. 1 after it is assembled.

FIG. 3 is a sectional view showing the inner structure of the massaging device of FIG. 1 along the 3-3 line.

FIG. 4 is a partial enlarged view of FIG. 3 showing the operation of the locking rod.

FIG. 5 is a side view showing the inner structure around the massaging balls of the massaging device of FIG. 1.

FIG. 6 is a sectional view showing the inner structure of the massaging device of FIG. 1 along the 6-6 line and how the massaging device is applied to the human body.

FIG. 7 shows the massaging device of FIG. 6 with the massaging balls configured differently.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

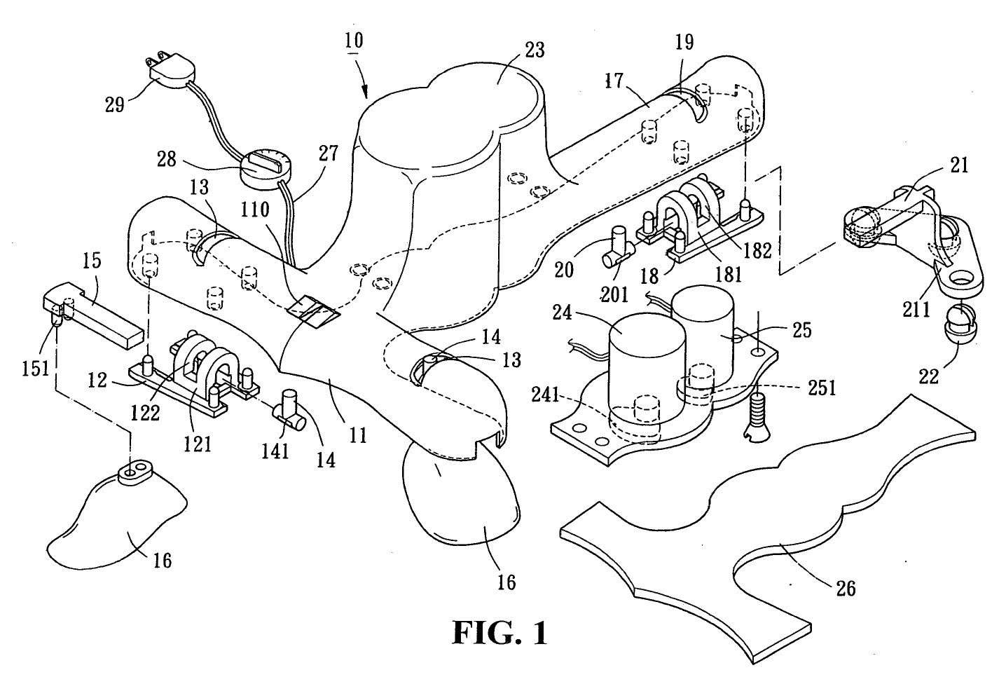

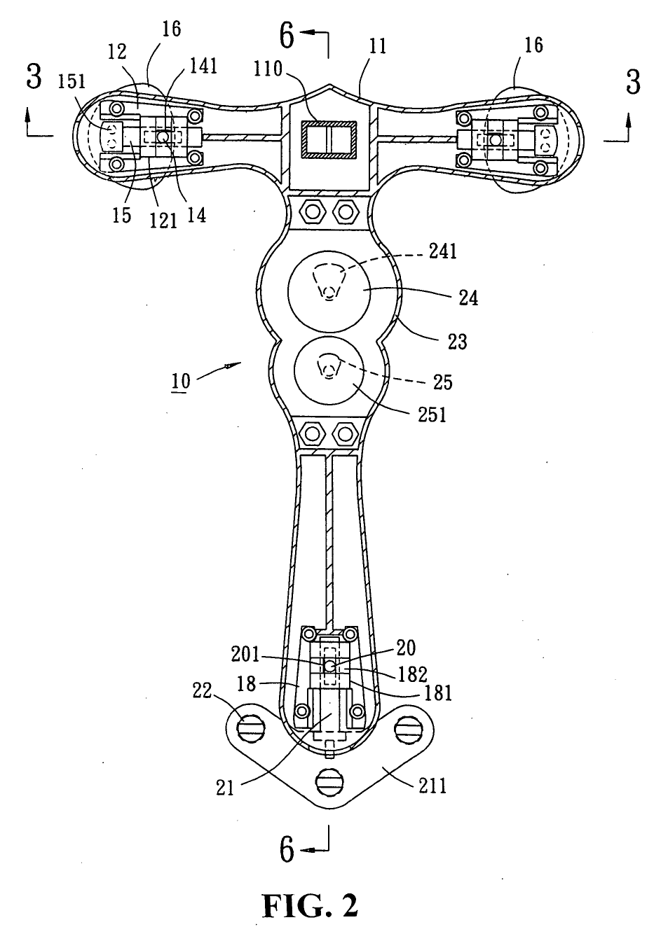

Please refer to FIGS. 1 and 2. As illustrated, the massaging device 10 according to the present invention has a T-shaped structure. When the massaging device 10 is used, the horizontal bar 11 of the T-shaped structure is positioned to be across the chest of a user while the vertical bar 17 is positioned along the torso of the user. For ease of reference, the side of the massaging device 10 facing towards the user is referred to as the front side and the opposite side as the back side. The horizontal bar 11 of the T-shaped structure has two positioning devices configured at the two ends of the horizontal bar 11 respectively. The positioning device has a saddle-like element 121 mounted on a plate 12 forming a tunnel through the saddle-like element 121. The saddle-like element 121 has a slot opening 122 orthogonal to the tunnel.

A slider 15 is threaded through the tunnel of the saddle-like element 121. A locking rod 14 is also positioned inside the tunnel of the element 121, which is on top of the slider 15 and sticking out of the slot opening 122. At the end of the locking rod 14 inside the tunnel, there is a bulge 141 closely touching the slider 15. At an end of the slider 15 that is extending outward from the massaging device 10, a cup 16 having the shape of a breast is attached with the cup 16's opening facing toward the front. Inside the cup 16, a number of bulges are configured along the inner wall of the cup 16 so as to enhance the massaging effect.

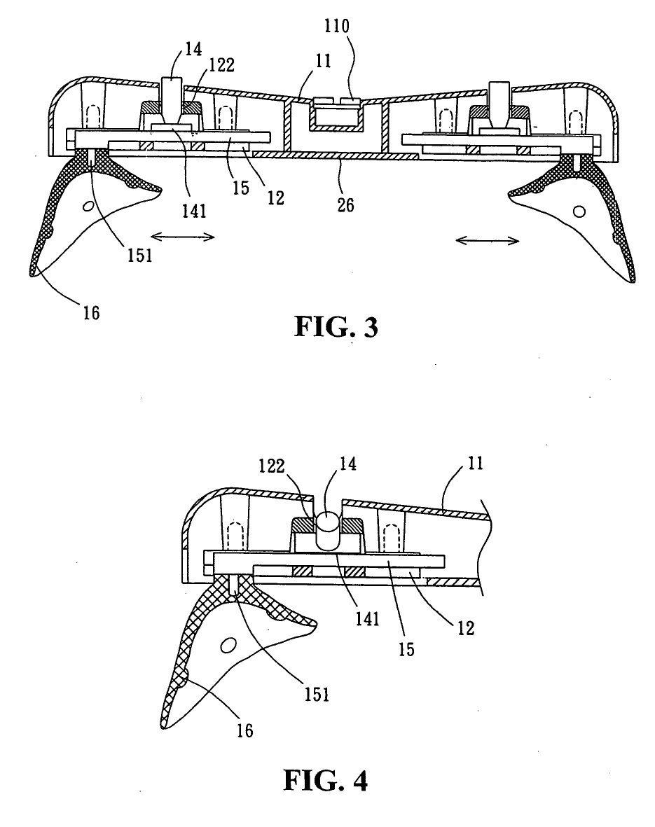

As shown in FIG. 3, the locking rod 14 is configured such that, when the locking rod 14 is flipped to an end of the slot opening 122, the bulge 141 of the locking rod 14 would be pressed tightly against the slider 15 so that the slider 15 is locked at its position. When the locking rod 14 is flipped to the other end of the slot opening 122, as shown in FIG. 4, the bulge 141 of the locking rod 14 is moved aside so that the slider 15 is released and could be slid freely along the tunnel of the element 121. In other words, by releasing the two sliders 15 at the two ends of the horizontal bar 11, the distance between the two cups 16 could be adjusted by manually sliding the two sliders 15 independently so as to fit the specific distance between the breasts of a particular user.

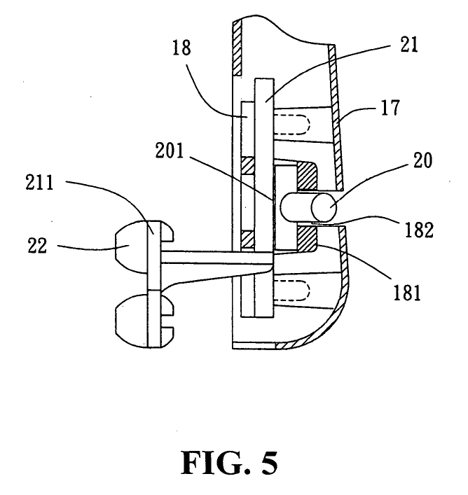

Please refer to FIGS. 1, 2, and 5. As shown, a positioning device is configured at the bottom end of the vertical bar 17, which has a saddle-like element 181 mounted on a plate 18 forming a tunnel through the saddle-like element 181. The saddle-like element 181 has a slot opening 182 orthogonal to the tunnel.

A slider 21 is threaded through the tunnel of the saddle-like element 181. A locking rod 20 is also positioned inside the tunnel of the element 181, which is on top of the slider 21 and sticking out of the slot opening 182. At the end of the locking rod 20 inside the tunnel, there is a bulge 201 closely touching the slider 21. At an end of the slider 21 that is extending downward from the massaging device 10, a triangular plate 211 is attached, whose three ends are configured with massaging balls 22 facing to the front respectively.

When the locking rod 20 is flipped to an end of the slot opening 182, the bulge 201 of the locking rod 20 would be pressed tightly against the slider 21 so that the slider 21 is locked at its position. When the locking rod 20 is flipped to the other end of the slot opening 182, the bulge 201 of the locking rod 20 is moved aside so that the slider 21 is released and could be slid freely along the tunnel of the element 181. As such, the positions of the massaging balls 22 could be adjusted by manually sliding the slider 21 so as to have the massaging balls 22 to rest upon the most comfortable positions on the user's abdomen.

Please refer to FIGS. 1 and 2 again. The massaging device 10 contains two electrical motors 24 and 25 housed inside a chamber 23 and sealed by a cover plate 26. The two motors 24 and 25 draw their required electricity via a power cable 27 having a plug 29 at an end. Along the power cable 27, there are a timer 28 for controlling how long the massaging device 10 runs, and a control switch 110 for selecting which one or both of the motors 24 and 25 to function.

The motor 24 has a lower rotational speed while the motor 25 has a higher rotation speed. The axes of the motors 24 and 25 are attached to two eccentric plates 241 and 251 respectively. The slower motor 24 is attached to the larger plate 241 and the faster motor 25 is attached to the smaller plate 251. When the motors 24 and 25 are running, the larger plate 241 driven to by the slower motor 24 is able to provide slower but larger vibrations, and the smaller plate 251 driven by the faster motor 25 is able to provide faster but smaller vibrations.

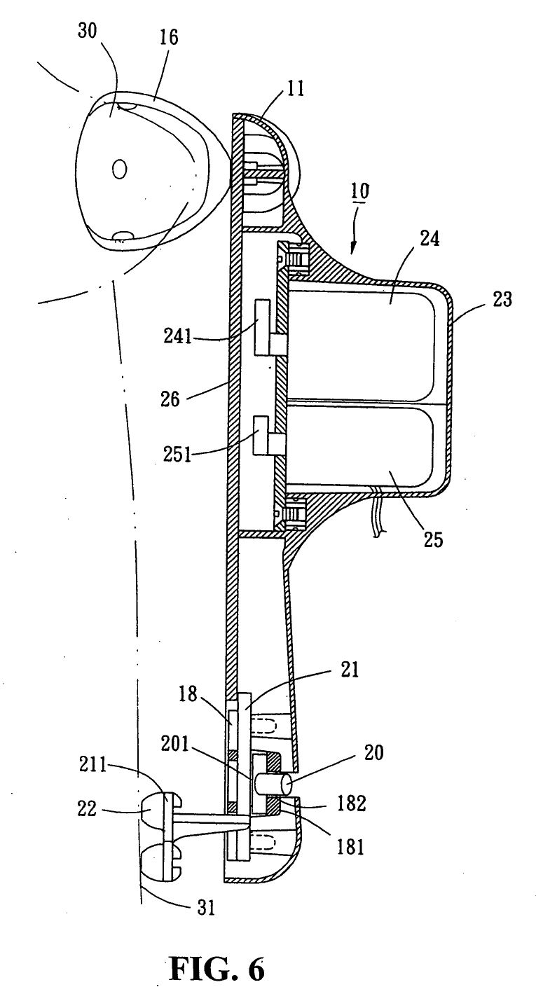

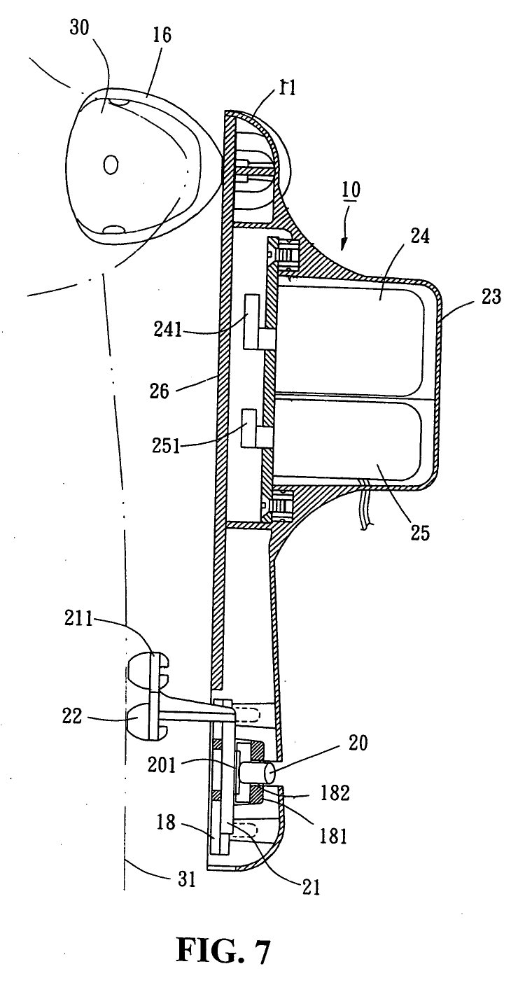

As shown in FIGS. 6 and 7, to use the massaging device 10, a user inserts the plug 29 to a power outlet first. The user could then lie down on the floor and place the massaging device 10 so that the horizontal bar 11 is on her chest and the vertical bar 17 on the abdomen. By releasing the locking rods 14, the user could adjust the positions of the two cups 16 so as to cover her breasts 30. Similarly, by releasing the locking rod 20, the user could place the massaging balls 22 on the most comfortable positions on her abdomen 31.

Please note that the slider 21 along with its triangular plate 211 and massaging balls 22 could be removed entirely from the tunnel of saddle-like element 181. The slider 21 could then be re-installed in a reversed direction so as to massage the user's upper abdomen as shown in FIG. 7, instead of the lower abdomen as shown in FIG. 6.

When the cups 16 and the massaging balls 22 are at their positions, the locking rods 14 and 20 are flipped to fixedly lock the sliders 15 and 21. The user then can turn on the massaging device 10 by the control switch 110. The control switch 110 also allows the user to choose to massage the breast 30 only (by running the motor 24 only), to massage the abdomen 31 only (by running the motor 25 only), or both (by running both motors 24 and 25). If required, the timer 28 could be set so that the massaging device 10 would turn off itself automatically after a specific period of time.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device for massaging the breasts and the abdomen of a user, said device having a T-shaped structure whose two ends of the horizontal bar of said T-shaped structure are configured with cups respectively for covering the breast of said user, and whose bottom end of the vertical bar of said T-shaped structure is configured with a plurality of massaging balls for placing on the abdomen of said user, said device having electrical motors for providing vibrations to said cups and said massaging balls either separately or simultaneously.

2. The device according to claim 1, wherein the two ends of the horizontal bar are configured with two positioning devices; each of said positioning devices comprises a saddle-like element mounted on a plate so as to form a tunnel; said saddle-like element has a slot opening orthogonal to said tunnel; a slider is threaded through said tunnel; a locking rod is positioned inside said tunnel and sticks out of said slot opening; said locking rod has a bulge at the end inside said tunnel such that, when said locking rod is flipped to an end of said slot opening, said bulge is pressed tightly against said slider to lock said slider at its position, and, when said locking rod is flipped to the other end of said slot opening, said bulge is moved aside to allow said slider to slide freely; and said cups are attached an end of said sliders respectively.

3. The device according to claim 1, wherein the bottom end of the vertical bar are configured with a positioning device; said positioning device comprises a saddle-like element mounted on a plate so as to form a tunnel; said saddle-like element has a slot opening orthogonal to said tunnel; a slider is threaded through said tunnel; a locking rod is positioned inside said tunnel and sticks out of said slot opening; said locking rod has a bulge at the end inside said tunnel such that, when said locking rod is flipped to an end of said slot opening, said bulge is pressed tightly against said slider to lock said slider at its position, and, when said locking rod is flipped to the other end of said slot opening, said bulge is moved aside to allow said slider to slide freely; and said massaging balls are attached to a plate which in turn is attached to an end of said slider.
